(19) United States
(12) Patent Application Publication
(10) Pub. No.: US 2019/0138715 A1
(43) Pub. Date: May 9, 2019

(54) POST SANDBOX METHODS AND SYSTEMS FOR DETECTING AND BLOCKING ZERO-DAY EXPLOITS VIA API CALL VALIDATION

(71) Applicant: JAYANT SHUKLA, SIERRA MADRE, CA (US)

(72) Inventor: JAYANT SHUKLA, SIERRA MADRE, CA (US)

(21) Appl. No.: 15/807,582

(22) Filed: Nov. 9, 2017

(51) Int. Cl. G06F 21/54; G06F 9/54; G06F 21/56; G06F 21/53

(52) U.S. Cl. CPC G06F 21/54; G06F 9/54; G06F 2221/033; G06F 21/53; G06F 21/566

(57) ABSTRACT

In one aspect, a method useful for monitoring and validating execution of executable binary code, includes the step of disassembling an executable binary code of an application. The method includes the step of detecting and obtaining location and type of an application programming interface (API) call, system call, and privileged instruction that is executed by the executable binary code. The method includes the step of detecting and obtaining return address from an Al call and system call. The method includes the step of validating location of the API call system call, and privileged instruction. The method includes the step of validating return from the API call and system call.

### BACKGROUND

Flaws or errors exist in almost very computer program and are generally referred to as software bugs. Software bugs can arise from incorrect design, coding, or assembly of computer programs. Following good practices in software design, coding, and testing reduces software bugs, but cannot eliminate them. When a software bug in a computer program is triggered during its execution, it may result into corruption of data or memory and cause the program to crash. Corruption of program memory is a vulnerability that can lead to exploits.

The design of modern computer systems permits the exploitation of software bugs to take control of the execution of a computer program and obtain unauthorized privileges, For example, a buffer overflow attack works by overwriting portions of an executing program's stack and heap memory locations with code provided by the attacker. Such an attack is feasible when the computer program does not validate input from the user before copying the buffer into memory.

Buffer overflow vulnerabilities are relatively easy, to introduce and have been exploited for many years. Due to the severe security implications of these exploits, several new methods have been introduced to prevent them. The most prevalent method is the use of canaries, that is, constant values inserted within critical sections of the program stack, the integrity of which can be confirmed during program execution, Another method, available in operating systems that support the No-eXecute (NX) bit, can prevent execution of code residing in certain areas of memory, for example, the stack, but it can also interfere with proper execution of some programs, such as those that decode their image on stack. While the use of the NX bit and canaries does prevent most buffer overflow attacks these techniques can be bypassed, and so do not constitute a complete solution.

Some advanced attacks do not inject new code into the application, but instead exploit legitimate functions to which the application has linked to carry out their malicious actions. Return-to-libc attacks, for example, use functions from libc, the standard library for the C programming language, to gain unauthorized access. Since the success of such attacks hinges on knowing the precise address of the function to be coopted, randomization of the load address of libc was introduced as a defense mechanism to mitigate them. With libc loading at a new address every time the program initiates, the exploit cannot use a fixed address to call functions from libc as part of its attack. While this technique was initially successful, it was soon learned that address space layout randomization could be bypassed by obtaining the address of libc functions from the procedure linkage table (PLT) of the program.

Recently a new class of attacks based on return oriented programming (ROP) has emerged which is able to defeat all existing methods for preventing exploits. These attacks provide the attacker with a fully functional language that is Turing-complete. Using ROP, the attacker can craft gadgets out of snippets from the code of the target program to implement any action he desires without injecting any detectable code during the attack. Some attempts have been made to apply address space randomization ideas to the structure of a program to prevent successful use of gadgets created from the program. Unfortunately, these methods impose additional cost, introduce compatibility challenges with existing monitoring tools, and do not offer guarantees that they can be robust against as yet unseen attacks.

Therefore, a need exists for systems and methods to protect clients from attacks that exploit unpatched or unknown vulnerabilities in computer programs. The solution does not take away functionality in order to improve security. The security mechanism should work seamlessly and without requiring anything from the user.

### SUMMARY

In one aspect, a method useful for monitoring and validating execution of executable binary code, includes the step of disassembling an executable binary code of an application. The method includes the step of detecting and obtaining an application programming interface (API) call that is executed by the executable binary code. The APl calls can include system calls and API calls to library functions, collectively referred to as API call from hereon. It is noted that, in some embodiments, a permutation of API calls, systems calls, and/or privileged instructions can be utilized. The method includes the step of listing a type of the API call. The method includes the step of listing a location of the API call. The method includes the step of listing a target of the API call. The method includes the step of listing a location of return from the API call.

The method includes the step of detecting a privileged instruction that is executed by the executable binary code. The method includes the step of obtaining the privileged instruction that is executed by the executable binary code. The method includes the step of listing a type of the privileged instruction. The method includes the step of listing a location of the privileged instruction.

The method includes the step of creating a rule set for validating the API call and the privileged instruction execution by the executable binary code. The method includes the step of transmitting the rule set to a validation code at an enforcement point. The method includes the step of loading a rule set in the memory of the validation code, wherein the rule set pertains to an API call type, an API call target, an API call location, an API call return location, a privileged instruction type and a privileged instruction location. The method includes the step during an execution of the application, monitoring the code to determine a conformity of the API call, system call and/or the privileged instruction made by the application with the rule set. The method includes the step of inserting a monitoring and validation code that, during execution of an application, generates an event based on the API call, system call and/or the privileged instruction. The method includes the step of transmitting the event stating the type, location address, target address, and return address for the observed API call or the location if privileged instruction. The method includes the step of transmitting the event based on the API call, system call and/or the privileged instruction to a validator application, wherein the validator application validates the rule set. The method includes the step of with the validator application: checking a conformity of the event based on the API call, system call and/or the privileged instruction with the rule set. The method includes the step of implementing a default action when a rule violation is detected for an event associated with an API call, system call and/or privileged instruction during the execution of the binary code. The method includes the step of and applying an additional validation for the API call system call and/or the privileged instruction in the executable binary code.

### BRIEF DESCRIPTION OF THE DRAWINGS

FIG. 1 illustrates a block ,diagram a computer network system, according to some embodiments.

FIG. 2 is an illustration of an example client computing system, according to some embodiments.

FIG. 3 illustrates an example process for generation of the rules used in validation of API calls, according to some embodiments.

FIG. 4 illustrates an example process performed by a validation process in permitting or denying an API call, according to some embodiments.

FIG. 5 illustrates an example process performed by a validation process, accordingto some embodiments.

FIG. 6 shows pplic n image that is instrumented for API-call rule enforcement.

FIG. 7 illustrates an embodiment where ne r odifications to application are utilized, according to some embodiments.

FIG. 8 an example process for API call monitoring, according to some embodiments.

FIG. 9 illustrates an example where a privileged instruction is executed on behalf of the application by a library function, according to some embodiments.

FIG. 10 provides an example process for disassembling an application to generate rules, according to some embodiments.

FIGS. 11A-B illustrates an example process for monitoring and validating execution of executable binary code, comprising the steps of, according to some embodiments.

FIG. 12 illustrates a process for validating execution of an application through a runtime validation process of an observed API call and ,a privileged instruction executed by the application, according to some embodiments.

FIG. 13 illustrates an example process for instrumentation of an application image usefulfor validating an execution of an application, according to some embodiments.

FIG. 14 illustrates an example process for creating and updating whitelist rules for use in validating application programming interface (API) calls in applications, according to some embodiments.

FIG. 15 illustrates an example process for applying additional validation to an event representing an application programming interface (API) call execution, according to some embodiments.

FIG. 16 illustrates an example process for reporting an observed API call and downloading a rule list for an execution of the API call, according to some embodiments.

The Figures described above are a representative set, and are not an exhaustive with respect to embodying the invention.

### DESCRIPTION

Disclosed are a post sandbox system, method, and article of manufacture for detecting and blocking zero-day exploits and unpatched vulnerability exploits via API call validation. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable mariner lr orae or more embodiments. in the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. in other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method indeed some arrows or other connectors may be used to indicate only the logical flow of the method, For instance, an arrow may indicate a waiting or monitoring period of unspecified duration between enumerated steps of the depicted method. Additionally, the order in which a particular method occurs shay or may not strictly adhere to the order of the corresponding steps shown.

Definitions

Example definitions fear some ert embodimentsare now provided.

Application programming interface (API) is a set of subroutine definitions, protocols and tools for building application soft are. An API call can include system calls and API calls to library functions. System calls are special class of API calls that wrap privileged instructions.

Control transfers in a computer program can be instructions that directs the fll of execution of the program. JMP, CALL, RET, IRET, and INT are examples of control transfer instruction.

Dynamic linked library (DLL) refers to a program module providing a set of API calls. The use of DLLs helps modularize programs and often used in providing interface to the operating system.

Disassembly of a binary code is the process converting machine executable instructions into human readable assembly code.

Dynamic analysis refers to execution of an application in a sandboxed environment to observe, record, and analyze its actions.

Executable applications can be files that contain computer program that can be executed on a computer. An executable application file has a specific format that enables the computer to load the file into memory and execute instructions in the file. Examples of, executable binary code are executable applications, dynamic linked library (DLL), kernel module, etc.

An event is information collected about the state of the process including register values, application stack, application process map, and application file attributes.

Hypervisor can be computer software, firmware or hardware that creates and runs virtual machines.

Hooking refers to a range of techniques used to alter or augment the behavior of an operating system, of applications, or of other software components by intercepting function calls or messages or events passed between software components. A software hook can be a set of code that handles such intercepted function calls, events or messages.

Libc is commonly used as a shorthand for the ‘standard’ C library,(e.g. a library of standard functions that can be used by various C programs).

No-eXecute (NX) is a technology used in CPUs to segregate areas of memory for use by either storage of processor instructions (code) or for storage of data, a feature normally only found in Harvard architecture processors.

Procedure Linkage Table (PLT) can be a part of the executable text section, consisting of a set of entries (one for each external function the shared library calls). Each PLT entry is a short chunk of executable code.

Processor register is a small set of data holding places that are part of the computer processor.

Return-oriented programming (ROP) is a computer security exploit technique that allows an attacker to execute code in the presence of security defenses such as non-executable memory (W xor X technique) and code signing.

Stack frame is collection of all data stored on the stack that is associated with a function call.

Virtual Machine Manager (VMM) is a desktop-drive virtual machine manager with which users can manage virtual machines (VM).

Whitelist can be a list or register of entities that provide a particular privilege, service, mobility, access or recognition. Entities on the list can be accepted, approved and/or recognized.

Zero-day vulnerability can refer to a computer-software vulnerability that is unknown to those (including the vendor of the target software) who would be interested in mitigating the vulnerability.

Exemplary Systems and Methods

In one example embodiments, an objective of the present invention is to protect computing devices from cyber-attacks wherein an adversary can exploit unknown or unpatched vulnerability in the software executing on the computing devices to gain unauthorized access. The adversary effects his aims by executing privileged functions on the computer system. A description and embodiment is provided for a deterministic method that prevents the unauthorized invocation of such functions, to include API calls, privileged instructions, and system API calls that wrap privileged instructions, collectively referred to as API calls from here on, during the execution of the application. The validation of API calls during the execution of the application is achieved by checking the consistency between the API call and the region of application code responsible for invoking the API call. The method's robust technique for determining allowable API calls overcomes the shortcomings of traditional whitelisting, blacklisting, and sandbox/heuristics/behavior-based security solutions, and makes it feasible to detect all exploits, and block any malicious code that is part of a exploit from executing, on the computing device.

Based on the discussion of prior art, it should be very clear to anyone well-versed in the art of cyber security that the utility of monitoring API calls to detect exploits is limited by our collective inability to set rules or heuristics that consistently discriminate the legitimate from the malicious, This invention describes a fundamental advance that solves this dilemma and provides a method to differentiate between malicious intent and a legitimate reason for an API call without requiring any special knowledge about the attack method or vulnerability on the part of the user.

In one embodiment of the invention, the bulk of the work is done on a remote server: the code of an application to be executed on a computer system is sent to a remote server where it is disassembled and scanned for API calls; the server creates a rule list based on API calls and their locations in the software; software hooks are placed in the code for monitoring API calls during program execution; the instrumented code is sent back to the client; the client executes the program, logging and sending to the server each observed API call, its location, and location of return from the API call; using the rule list, the server determines whether the event is compliant; if the event is non-compliant, a secondary validation technique is applied to reduce false positives; appropriate action is taken.

Secondary validation plays a crucial role in the robustness of the invention, providing a way to resolve disassembly ambiguities and flag true attack events. To perform the secondary test, upon receipt of an event, the corresponding application executable binary is disassembled; a list of all instructions is generated; a list of all API calls is generated; the received event is matched with the disassembled binary at the locations that are consistent with known instructions and API calls. If the exact memory location, return location, and type of API call are not consistent with the information extracted from the disassembled executable binary, the event is considered invalid. If the event is an API call, two additional checks are made. The first check is pointer consistency and the second check is API call argument validation. These two additional checks are strong conditions for validating an event.

Both rule list generation and secondary validationare deterministic and automatic—they do not require human intervention. These features provide a tremendous advantage over traditional black/white list-based approaches that always require a human in the loop to make the final decision.

In a variation of the first embodiment, once the server has created the rule list, it sends the list to the client and the client validates events. Splitting the work in this way cuts down on network activity, but can still keep the compute-intensive tasks at the server.

In a second embodiment of the invention, all of the work is done on the executing computer: the code of the application to be executed is disassembled and scanned for API calls; a rule list based on API calls and their locations in the software is created; software hooks are placed in the code for monitoring API calls during program execution the computer executes the program, validating each observed API call in turn; and taking appropriate action.

In a third embodiment of the present invention API calls are monitored without modifying the application binary: the code of an application executing on a computer system is scanned for API calls; a list of API calls and their locations in the software is created; software hooks are placed for monitoring API calls during program execution; during the execution of the program the type, location address, and return address of observed API calls are compared with information about expected API calls; events are logged; prescribed action is taken if an observed API call is not compliant. It is noted that the software hooks are placed in the kernel.

In a fourth embodiment of the invention the application binary is modified for monitoring API calls: the binary code of an application executable stored on a computer system is disassembled and scanned for API calls; software hooks are placed for monitoring API calls during program execution; a new executable is created; during the execution of the program the type, location address, and return address of API calls are compared with information about expected API calls; events are logged; prescribed action is taken if an observed API call is not compliant.

In a fifth embodiment of the invention the rule list is generated not from disassembly en masse but from observing and analyzing executing API calls. The execution of the application is monitored and events are collected. The monitoring of the application continues for a period of time and based on the collected events, a rule list for all API calls is generated.

A benefit of using authentication of API calls for preventing cyber-attacks is that the solution does not use information about cyber-attack method or the vulnerability it exploits; it does not rely an rules or heuristics to be configured by the user. Another advantage is the ability to detect and block cyber-attacks before any harmful malicious instructions are executed. As discussed above, since traditional black- and whitelisting-based methods for API call filtering rely on attack catalogues, they will never catch all attacks, especially new ones. Often, the attack can be detected only after malicious code has already executed on the computing device and caused significant harm. In contrast, the task of generating a list of rules for controlling the API calls and privileged instructions executed by applications is simple and deterministic. it can be automated much more efficiently than can the generation of a black list of potential attacks and attack vectors.

A change in the state of a computer system is achieved by executing privileged instructions on the processor of the computer system. Often, privileged instructions are wrapped in system API calls which, in turn, are wrapped in standard API calls provided by libraries. Some examples of API calls are write( ), read( ), open( ), and fork( ), to name just a few. Some examples of privileged instructions are sysenter and int. An attack on a computer system via exploitation of a zero-day, or unpatched vulnerability is successful only if the attacker can execute API calls and privileged instructions. If an exploited vulnerability changes a program's execution, then by definition, the API call and privileged instruction execution pattern can also change, and the attack can be detectable. In the following, the term API call can again be used to refer to all the types of privileged instructions mentioned above.

The present invention uses a rule list to monitor and enforce API calls during program execution. In one embodiment of the present invention, authentication of program execution is accomplished by observing its action from a more highly-privileged process. No modifications to the program being protected are necessary. In another embodiment of the present invention, authentication of program execution at the byte level is accomplished via dynamic or static instrumentation of the application image that is executing in the memory of the client computing device.

In one embodiment, a deterministic method can be utilized (e.g. instead of heuristics) tto mediate API calls. Instead of forcing the user to rely upon heuristics to build and configure a set of rules, one example embodiment can extract information from the internal structure of the code to generate rules and then, during the execution of the code, validate activity against them.

Whitelisting, the concept of, a priori, only allowing predetermined functions to run, is commonly used to block attacks on applications. The seccomp security feature of the Linux kernel, for example, provides a mechanism to restrict API calls by type. The restriction is at the discretion of the user, and while it provides some security, it does not prevent the attacker from using whatever permitted API calls remain to inflict damage. The advantage of the present invention is its ability to detect and block almost every category of zero-day exploits without relying on the user's knowledge of attack signatures. Further, some may embodiments may not require access to the source code, a very significant advantage over the method used in seccomp, as assuming access to third-party source code and recompilation of applications is not practical.

Coarse-grained methods focus on the broad behavior of applications, can monitor the API calls made by them. Type or sequence of API calls, file system changes, new process creation, etc., are some of the tell-tale signs of a zero-day exploit that can be detected by these coarse-grained methods. The enforcement of coarse-grained methods can be based on sand boxes, host-based intrusion prevention systems (HIPS), or virtual machine monitors (VMMs). These implementations have little visibility into the execution of an application, and the actual exploit mechanism is typically not detected. The limitations of coarse-grained behavior-based methods are two-fold. First, they do not stop the exploit. Second, as the actions that follow an exploit often overlap with known actions of the application these methods have difficulty separating normal execution from zero-day activity.

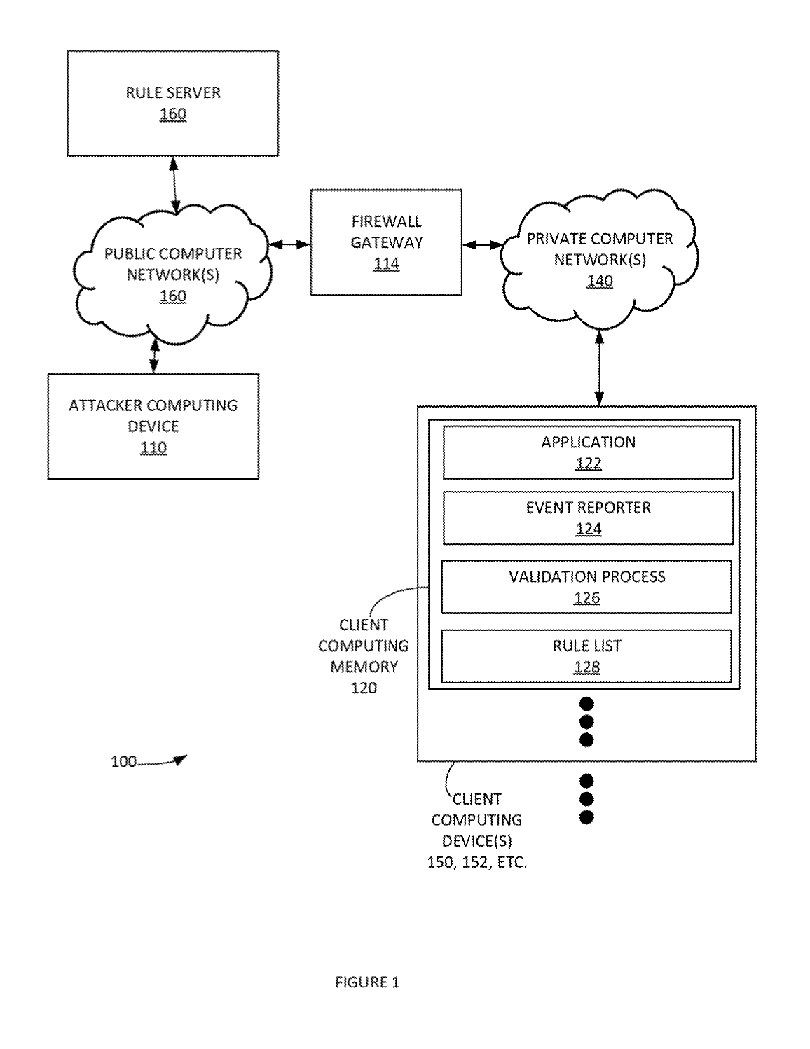

FIG. 1 illustrates a block diagram of a computer network system 100, according to some embodiments. One or more networked client computers 150 152 connect to each other and to other client computer(s) through networks 112. Any one of the client computers can be an attacker (e.g. attacker 110). The identity and intentions of the attacker may not be known to the other client computers. Network 112 between the client computers can include a range of components such as routers, switches, firewalls, content filters, proxies, and other hardware, that route the data transmitted between the client computers. The network between the client computers can be a public network 112 (e.g. the Internet, etc.) or a private 140 networks and/or a combination thereof. Client computers 150 and 152 can be computing devices such as a personal computer, notebook computer, workstation, server, smartphone, or the like. While computer network system 100 depicts only two client computers, one attacker, and one policy server, theembodiments of the computer network system may contain multiple instances of each.

For the embodiment illustrated in FIG. 1, system 100 includes a client 150 that executes a range of applications such as applications 122 and 124. Applications 122 and 124 can include vulnerabilities that can be targeted and exploited by attacker 110. In memory 120 of the client 150, validation process 125 can be executed. Validation process 126 can detect and prevent various attempts to exploit vulnerabilities in the code of applications executing on the client 150. Validation process 126 can monitor and validate API calls executed by the applications. Validation process 126 can be implemented as a service, application, Da, kernel module, or hypervisor. Validation process 126 can monitor the assemblage of code executing in the memory 120 of the client. Validation process 126 can monitor the code being executed. Validation process 125 can monitor API calls. Validation process 126 can validate API calls using a rule list 128 for each code. A default action can be taken when a violation is detected. In one example, monitoring, validation, and enforcement of API calls by the code can be separated. In another example, the observed API calls at computing device 150 can be eported to the rule server 160 where the rule set is applied to detect violations.

As shown in FIG. 1, the validation of API can call during the execution of the program is based onrule list 128. The rule list can be stored locally and/or downloaded from rule server 160 by the validation process. The rule list can include rules for each application or module, depending on its version and characteristics. A rule, in one example form, specifies the type and memory addresses involved in the API call. In another form the rule may involve the memory address of return from the API call. In some examples, two different versions of the same application can have different rules. When the rule list has been generated from the original application image, rules can be adjusted to reflect new API call locations if monitoring is accomplished via an instrumentation process that changes the binary. The validation process loads the rule list into the memory space of the application where the validation is performed.

In one example, the validation is performed by instrumenting the application code itself. This can improve performance by avoiding context switching during validation. The instrumentation can also be applied at the kernel, hypervisor, or firmware. Furthermore, the instrumentation to insert the validation code into the application binary can be done statically or dynamically. When the validation code is part of the application binary or runtime image, the application may change, and rules can be interpreted correctly to account for relocated API calls.

In one embodiment, the validation is separate from the application and the rules can be applied directly, as the application image may not change. The validation process can be implemented at several locations on the client 150, including, but not limited to VMM and kernel. As long as the validation process can observe and control API calls for applications executing on the client, the validation process can detect and block exploit attack attempts. When an API call is observed by the validation process, its calling location, target address, type of API call, and return location are validated.

In one embodiment, the rule list 128 can be continually updated as client computers execute applications. As shown in FIG. 1, the application validation process 126 monitors each API call and periodically communicates with the rule server 160 to download updates to the rules. In another embodiment, this information can be collected by executing the applications in monitoring mode. Each executing application is observed for API calls and the collected information is reported to the rule server 160. The rule server analyzes the collected data for any given application for consistency with samples collected from other clients. The samples can also be collected by directly executing applications in a controlled environment. A rule can be created if the observations of any given API call in an application are consistent with each other andl are consistent with the structure of the binary. The first consistency check can have the observed API call align with instruction boundaries of the disassembled executable binary. The second consistency check can state that the location of the observed API call be consistent with the observed API call or corresponding library function. The third consistency check can determine that the argument used in the API call is consistent with the binary structure of the disassembly of the executable binary.

The updated rules can be sent back to the clients and added to the rule list 128. While the embodiment discussed here uses the rule server 160 to perform the analysis, it is not limited to it. The analysis of API calls in an application and generation of rules can also be performed locally at the enforcement point 150.

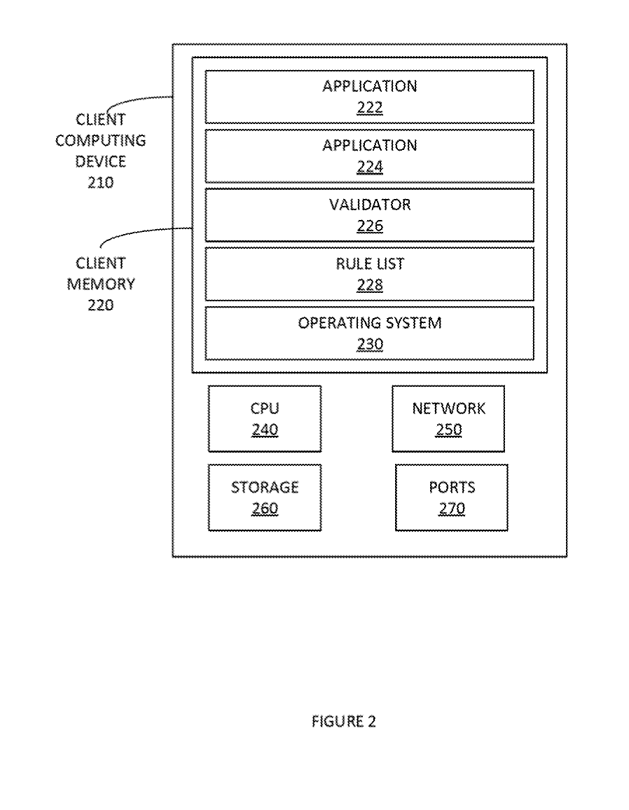

FIG. 2 is an illustration of an example client computing system 210, according to some embodiments. The monitoring rule generation, and validation steps can be applied by the same, computing device, such as, client computing system 210. Client computing system 210 can execute a range of applications 222 and 224. Client computing system 210 can include memory 220. In merriory 220, client computing system 210 can execute a monitoring, and enforcement process, such as, validator 226. Validator 225 can monitor API calls executed by applications and to enforce rules. Validator 226 can be implemented as an application, kernel module, hypervisor, or DLL. Validator 226 can monitor the assemblage of applications executing in memory 220 of the client. Validator 226 can monitor API calls. Validator can execute at a higher privilege than the application process or within the application process. Validator 225 can validate collected events. The validation of collected event is based on the of alignment of the event instructions with the generated disassembly. Further, the instructions for the event can be consistent with the instructions at the corresponding location in the application binary. The execution trace for the event are can consistent with the arguments used in the API call that is part of the event. Application(s) 222 can be protected against attacks using a rule list 228. In accordance with one example, the monitoring, validation, and enforcement of API calls by the code are part of the validator process performed by validator 226.

Computing system 210 can include additional components including, inter alia, central processing unit 240, storage device 260, network device 250, and input/output port 270. While the computing system illustrated here has been illustrated with a single CPU, storage device, network device, and input/output port, it is noted various different configurations of the computing system can incorporate more than one of the individual components, as well as, other components. For example, the computer system may further include random-access memory (RAM), erasab e programmable read-only memory (EPROM), read-only memory (ROM), compact disk ROM (CD-ROM), storage area network (SAN), or any other storage medium that can be accessed by computing system 21.

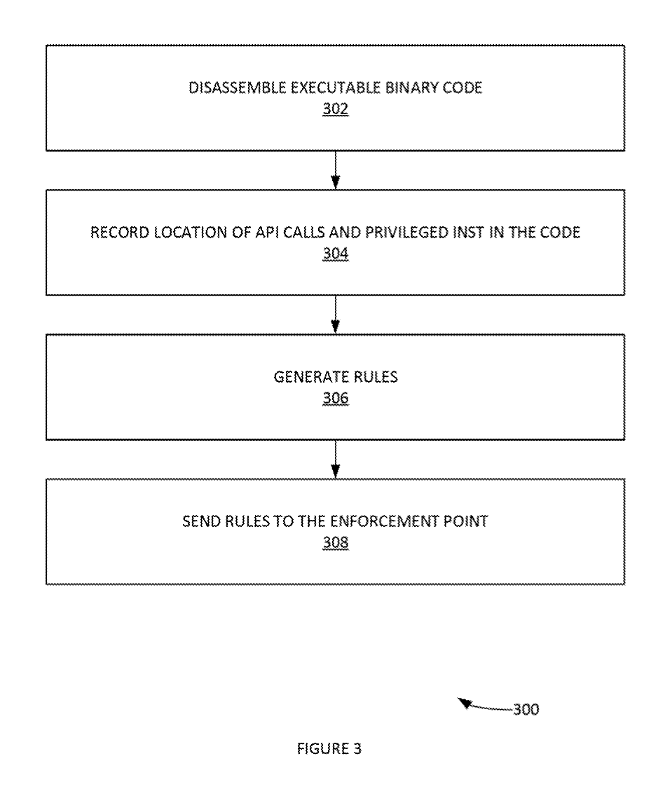

FIG. 3 illustrates an example process 300 for generation of the rules used in the validation of API calls, according to some embodiments. Target code from, inter alia, an application, driver, DLL, hypervisor, or firmware can be disassembled in step 302. From the disassembled code, the location and type of API calls are recorded in step 304. The API calls can include system calls and API calls to library functions.

Based on the recorded API calls, a rule>Iist is generated in step 306 by applying a validation mechanism to the location of each API call. Validation can ensure that a recorded API call is consistent with the binary structure of the code and part of ,a possible execution trace for that binary. One example of checking consistency involves using knowledge about the API call and its arguments. Based on how the arguments used by the API call are loaded into the registers serves as partial validation. The check can be further enhanced by validating the type of each argument. Once an API call has been validated, a rule is created by specifying the type and location of the call. When all the API calls have been validated, the generated rule list is transmitted to an enforcement point in step 308. At the enforcement point, the generated rule list is used to permit or deny execution of API calls based on the outcome of the validation of observed API calls.

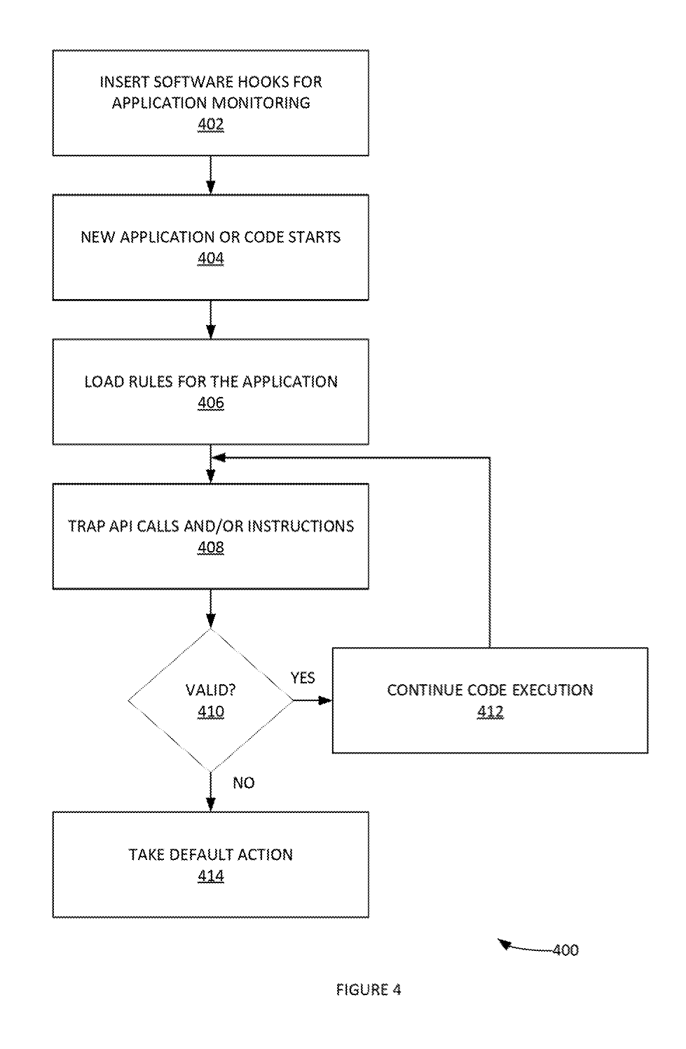

FIG. 4 illustrates an example process 400 performed by a validation process in permitting or denying an API call, according to some embodiments. API call validation is accomplished during the execution of applications. Monitoring and validation hooks can be placed 402 that may be either system-wide, or for each process or module. Hooks can be placed by modifying the code of the application or module that is to be protected.

In step 404, the new application or code is started. The validation process enumerates applications on the computing device by scanning the storage media attached to the computing device or by monitoring any process starting or modules executing on the computing device. A rule list for each module in the application process is loaded in step 406. When an API call is executed by the code in step 408. The validation process uses the rule list for that application process to determine if the API call, system call and/or privileged instruction can be permitted in step 410. If the rule is violated, an event is logged and default action is performed in step 414, otherwise the application process continues its normal execution in step 412. The code for validation of API calls can also be used in a monitoring mode to generate a rule list dynamically. In monitoring mode, upon encountering an API call, an event is logged and the code execution is allowed to proceed. The enforcement of API calls executed by the application can also be accomplished without having to modify the application code.

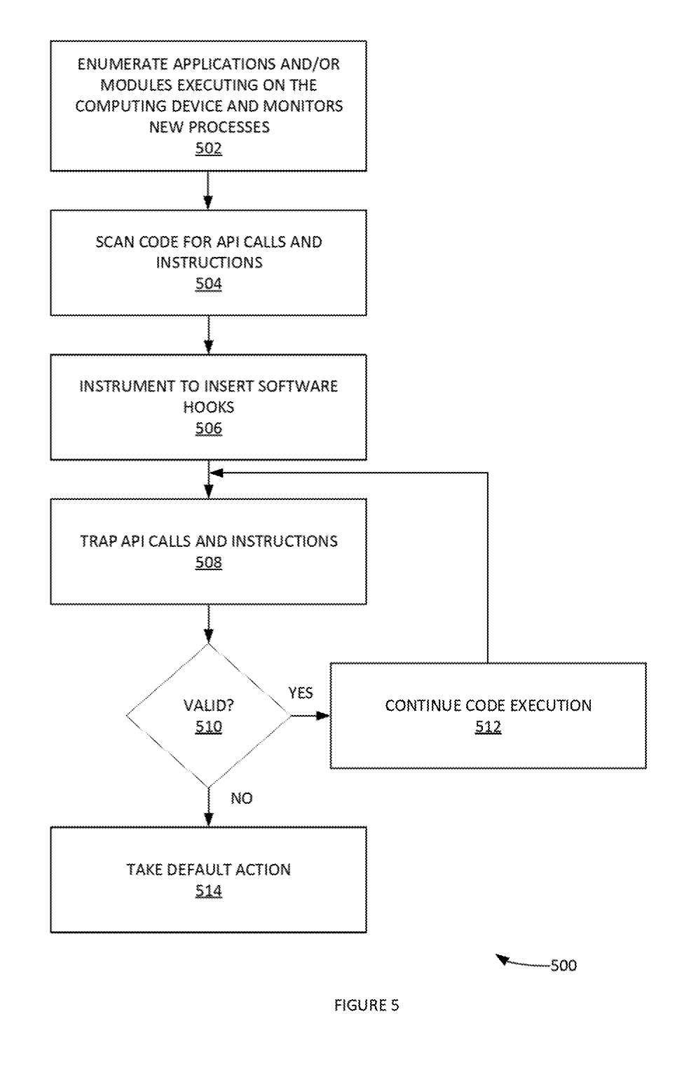

FIG. 5 illustrates art example process 500 performed by a validation process, according to some embodiments. The validation of API calls during the execution of application code can be accomplished via instrumentation of the application image. The validation process can enumerate applications and/or modules executing on the computing device and monitors new processes starting on the computing device in step 502. The image of the application loaded in the memory is disassembled and scanned for API calls in, step 504. Code for validating or monitoring API calls is inserted in the application in step 506. Alternatively, the image of he application is statically instrumented and the hooks (e.g. code for capturing an API call) for monitoring API calls are part of the binary and no additional instrumentation is used at runtime. The instrumented application image executes on the computing device. In step 508, API calls and instructions can be trapped.

When an API call point is reached during program execution, the validation process uses the rule list for that process to determine if the action can be permitted in step 510. If the rule is violated, an event is logged and default action is performed in step 514, otherwise the program continues its normal execution in step 512. The code for validation of API calls can also be used in monitoring mode to generate a rule list dynamically. An event can be logged and the API call is allowed to proceed. The validation can also be enforced by inserting the validation code after the API call and validating the return to address.

Implementation of instrumentation for the purpose of API call validation can be achieved in various ways. Potential methods include, inter alia, substituting the file handle of the executable with that of an instrumented application executable, instrumenting the application image in memory, and trapping API call execution in a VMM.

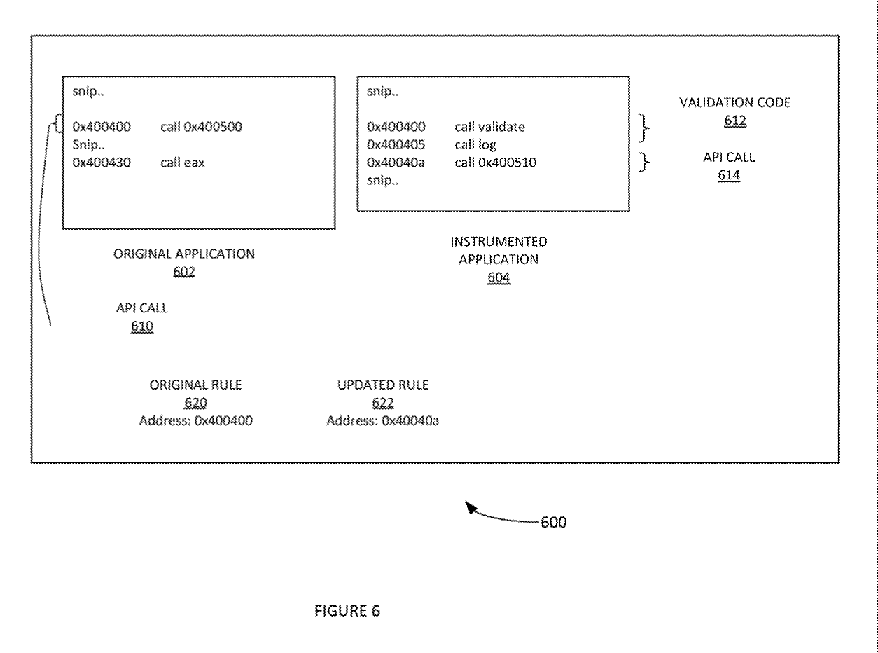

FIG. 6 shows an application image 600 that is instrumented for API-call rule enforcement. The original application image 602 has an API function call 610 at memory location 0x400400. API function call 610 can call a function at memory location 0x400500. A corresponding rule exists for original rule 620. In the instrumented image of application 604, validation code 612 can be inserted before the API function call to be validated. The API function call has moved to a new memory location 614. During program execution, the validation code validates the API function call before permitting it. The new validation of the API function call rule 622 is updated to reflect the start location value as 0x40040a and the destination location value as 0x400510, Application image 600 is provided by way of example and not of limitation.

When an API call, system call or privileged instruction execution is based on a computed variable, a corresponding rule cannot be created by static analysis of the application executable. Accordingly, FIG. 6 shows the disassembled code at address 0x400430 indicating an API call by via the eax register. The actual API call resolution can be difficult by static analysis. By examining the register value at runtime, it becomes possible to obtain the information about the API call and create a rule. In accordance with one aspect of the present invention, the monitoring application captures additional information about registers and ystem state for the purpose of resolving any variable that may be used in invoking API calls, The, observed value can be used to create a rule locally or reported to the rule server.

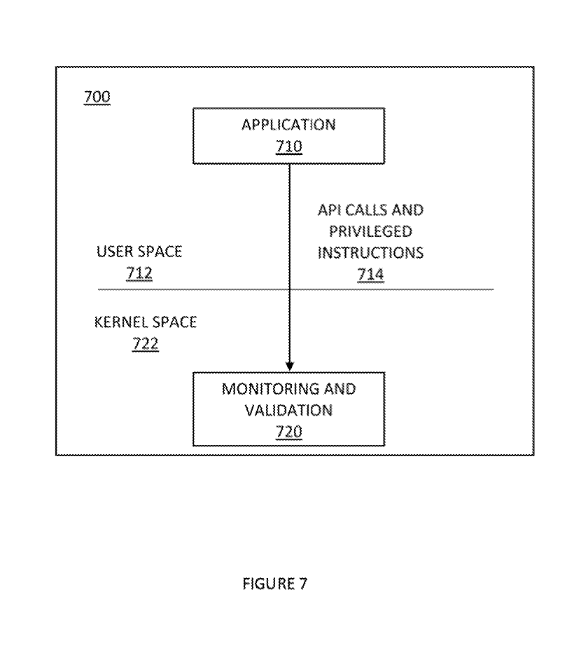

FIG. 7 illustrates an embodiment 700 where no modifications to application 710 are utilized according to some embodiments. Embodiment 700 can monitor and enforce in the kernel space 722 and not in the user space 712. The hooks for monitoring API calls by the application can be placed in the kernel space 722. These hooks may be system-wide and/or specific to an application. If the hooks are system-wide then the kernel module 720 can monitor every API call 714 execution. An example of such a hook can be the use of kernel probes in the LINUX® kernel. By adding, a probe for each API call, embodiment 700 can record every API call. A separate mechanism can be used to filter the events and assign said events to their respective process or application. In addition to recording the API call, additional information is collected to improve the analysis of the API call. This information can include the value of the CPU registers, kernel stack, and application stack. Embodiment 700 can monitor the type and location of API calls by an application from the kernel.

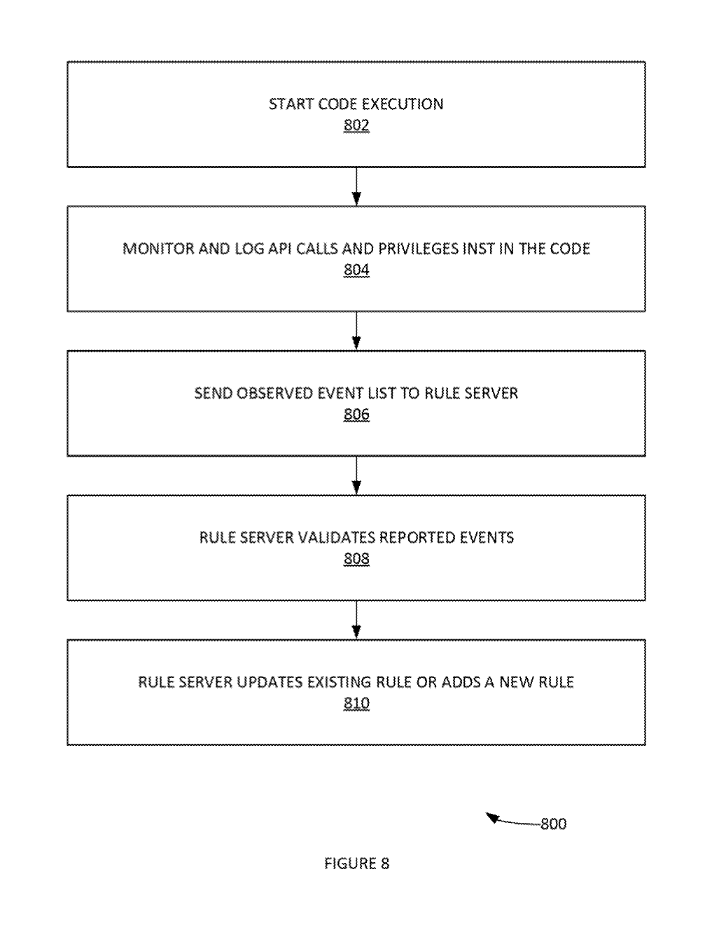

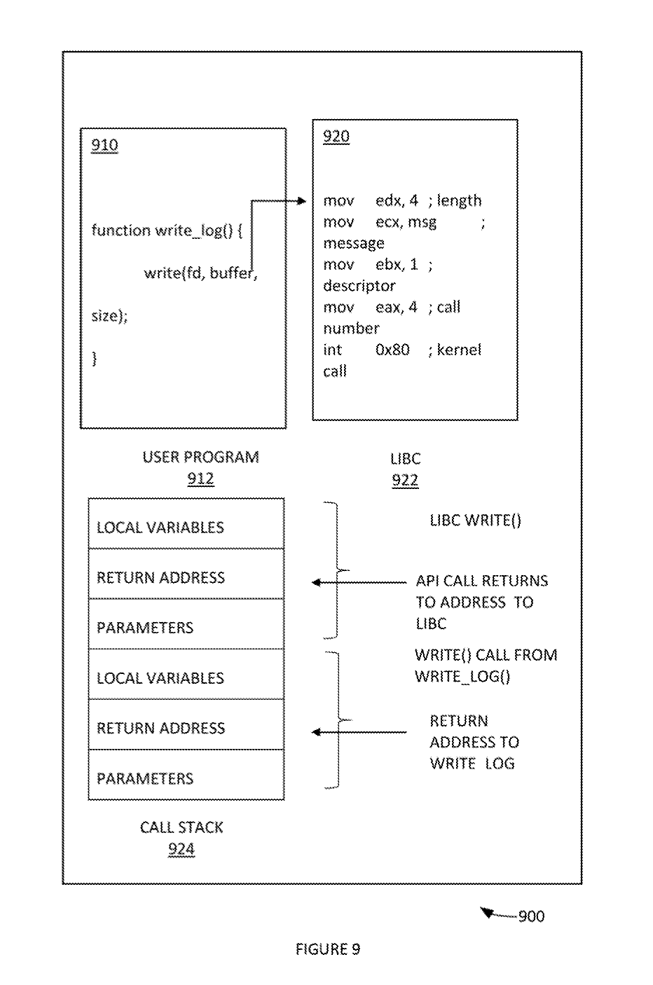

FIG. 8 an example process 800 for API call monitoring, according to some embodiments. The program can be executed in a controlled environment in step 802. The instrumentation can be static or dynamic. API calls in the program are monitored and logged in step 804. Collected events are transmitted to the rule server in step 806. The rule server analyzes and validates collected events in step 803. New rules are created and added to the rule list 810. The updated rules are downloaded by the validation process for enforcement.

1The validation'method is also applied to all un or API calls that invoke API calls. The validation of API calls by an application can be masked when the API call is executed by another module or library on behalf of the application. In these examples, the originator of the API call and privileged instruction can be another module. Accordingly, FIG. 9 illustrates an example 900 where a privileged instruction is executed on behalf of the application by a library function, according to some embodiments. The application can have a function write_log that invokes the write( ) API call to write a file. The write( ) call made by the application may not actually invoke the function, but can point to a function in libc. In turn, libc 922 obtains the parameters supplied by the program and invokes the system call. The pseudo code of a program 912 shows a function calling the write( ) API function in libc 922. The disassembly of the write( ) API function in libc 920 shows the actual system call being made. Each function call adds a new frame to the stack. By traversing the call stack, example 900 find the actual location in the application code that is responsible for invoking the system call. The validation enforcement can either be based on the address of the origin of the API call or the address to return from the API call. The validation of API call can use the return address on the stack to validate the rule for the API call. The validation method enforces the location restriction of the API call even though the call resulted in a system call by the library.

Accordingly, it is noted that systems and methods for validation of API calls and privileged instruction execution in applications are provided. The specifications and drawings are not intended to limit the exclusionary scope of this patent document.

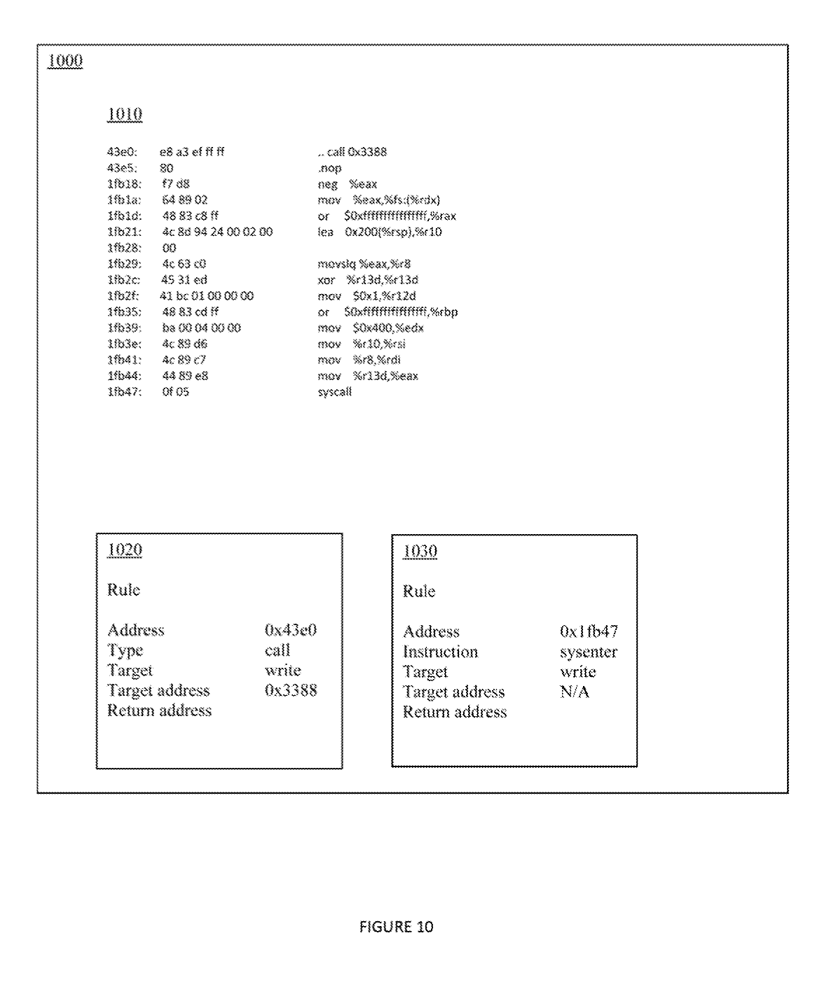

FIG. 10 provides an example process 1000 for disassembling an application tai generate rules, according to some embodiments. The disassembly of the application 1010 shows an API call to libc at address 0x43e0. Then disassembly of the application 1010 shows an API call by libc at address 0x1fb47. Accordingly, the two rules are generated. The first rule 1020 specifies the location type and target of the API call at address 0x43e0, as well as the return address. The second rule 1030 is for the API call to the kernel, The rule states the target address, return address, instruction, and target type. The target address is not specified, as the API call is to the kernel and involves a context switch.

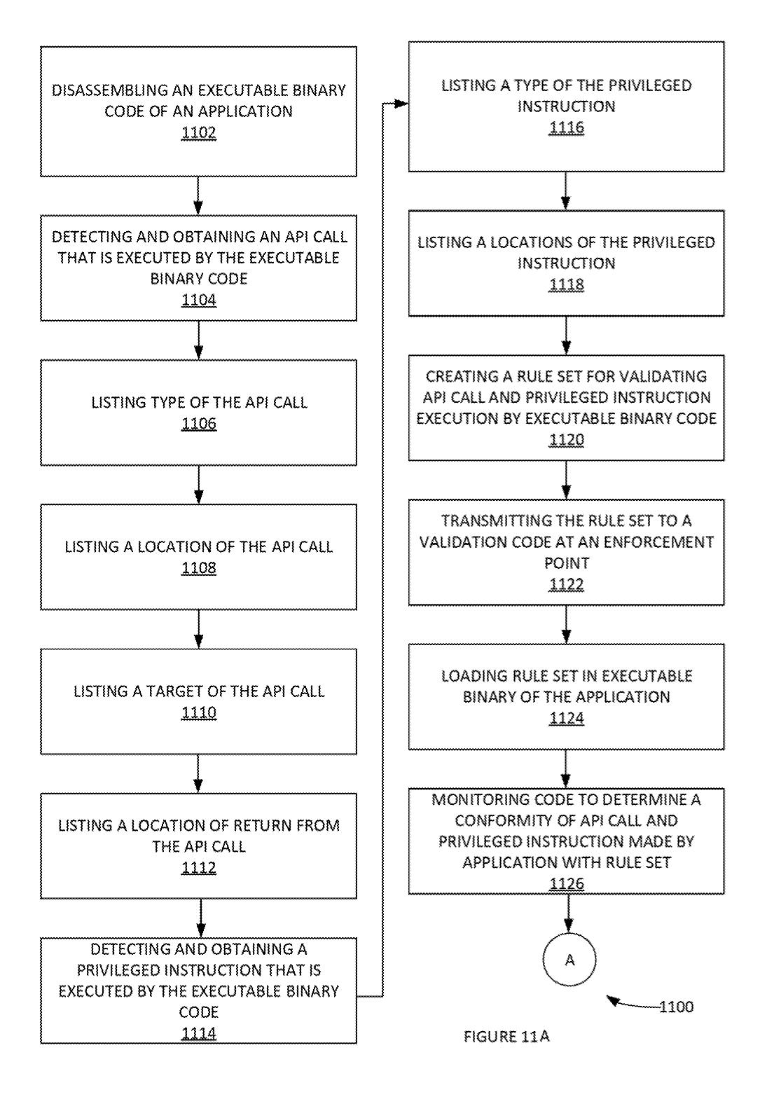

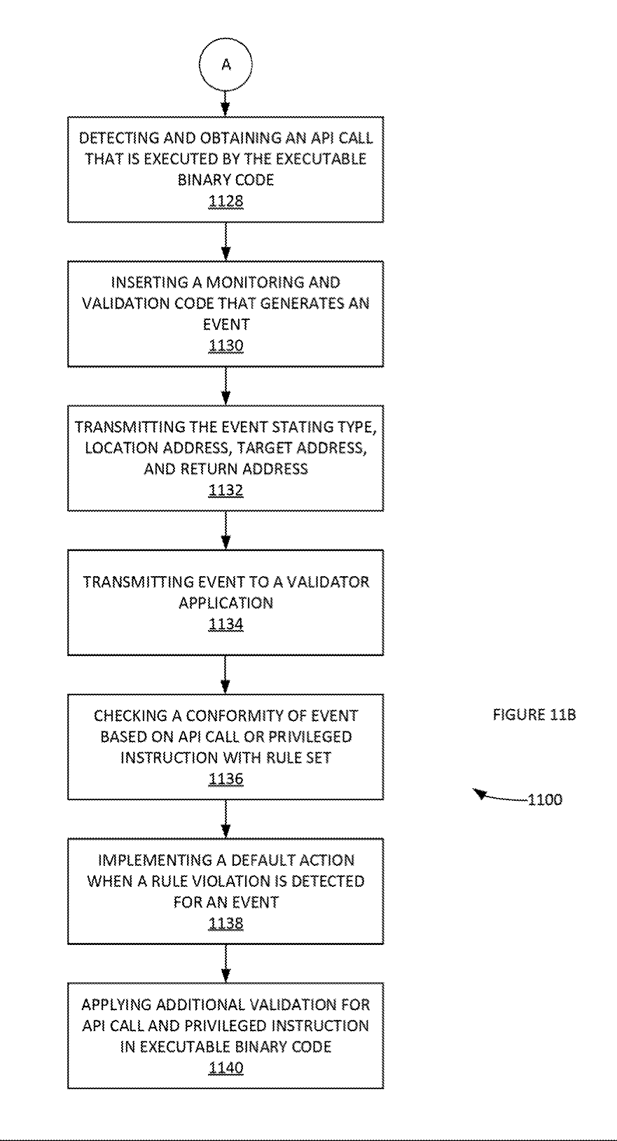

FIGS. 11 A-8 illustrates an example process 1100 for monitoring and validating execution of executable binary code, comprising the steps of, according to some embodiments. In step 1102, process 1100 can disassemble an executable binary code of an application. In step 1104, process 1100 can detect and obtaining an API call that is executed by the executable binary code. In step 1106, process 1100 can list type of the API call. in step 1108, process 1100 can list a location of the API call. In step 1110, process 1100 can list a target of the API call, in step 1112, process 1100 can list a location of return from the API call. In step 1114, process 1100 can detect and obtain a privileged instruction that is executed by the executable binary code. In step 1116, process 1100 can list a type of the privileged instruction. In step 1118, process 1100 can list a location of the privileged instruction. In step 1120, process 1100 can create a rule set for validating the API call and the privileged instruction execution by the executable binary code. in step 1122, process 1100 can transmit the rule set to a validation code at an enforcement point. In step 1124, process 1100 can load a rule set in the executable binary of the application. The rule set pertains to an API call type, an API call target, an API call location, an API call return location, a privileged instruction type and a privileged instruction location. In step 1126, process 1100 can, during an execution of the application, monitor the code to determine a conformity of the API call and the privileged instruction made by the application with the rule set. In step 1125, process 1100 can insert a monitoring and validation code that, during execution of an application, generates an event based on the API call or the privileged instruction. In step 1128, process 1100 can transmit the event stating the type, location address, target address, and return address for the observed API call or the privileged instruction. In step 1130, process 1100 can transmit the event based on, the API call or the privileged instruction to a validator application, wherein the validator application validates the rule set. in step 1132, process 1100 can, with the validator application, check a conformity of the event based on the API call or the privileged instruction with the rule set, in step 1134, process 1100 can implement a default action when a rule violation is detected for an event associated with an API call, system call or privileged instruction during the execution of the binary code. In step 1136, process 1100 can apply an additional validation for the API call and the privileged instruction in the executable binary code.

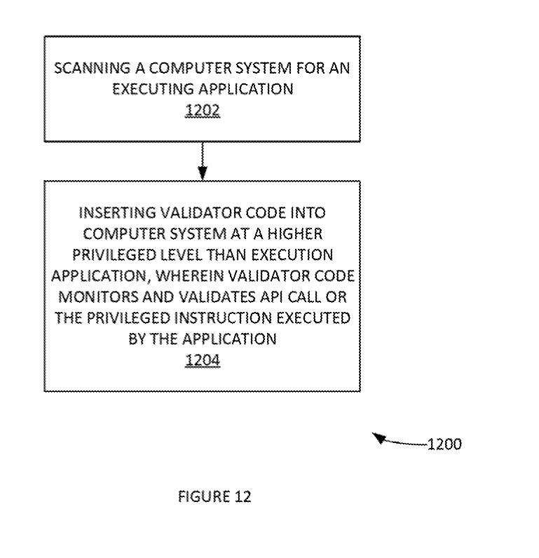

FIG. 12 illustrates a process 1200 for validating execution of an application through a runtime validation process of an observed API call and a privileged instruction executed by the application, according to some embodiments. In step 1202 process 1200 can scan a computer system for an executing application. In step 1204, process 1200 can insert validator code into the computer system at a higher privileged level than the execution application. The validator code monitors and validates the API call or system call leading to privileged instruction execution by the application.

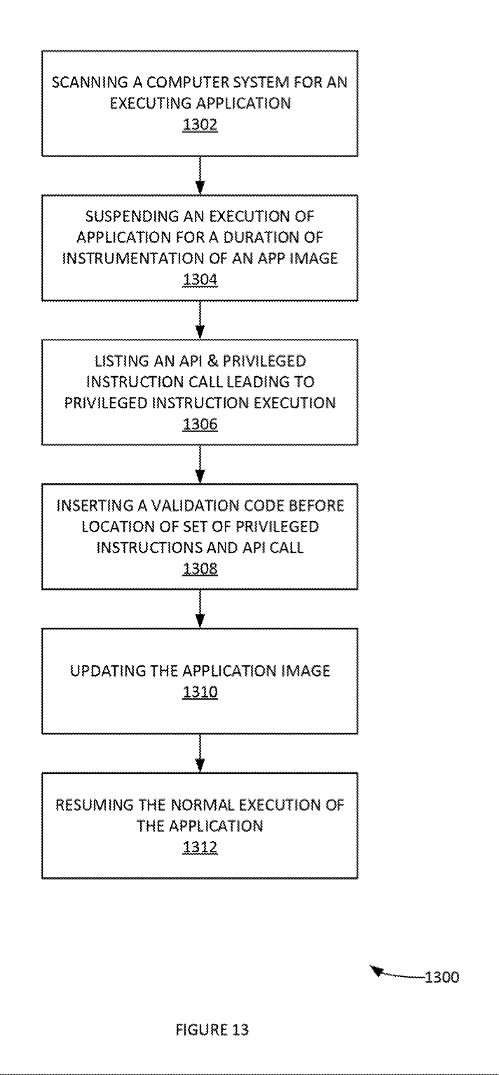

FIG. 13 illustrates an example process 1300 for instrumentation of an application image useful for validating an execution of an application, according to some embodiments. In step 1302, process 1300 can scan a computer system for an executing application. In step 1304, process 1300 can suspend an execution of the application for a duration of instrumentation of an image of the application. In step 1305, process 1300 can list an API and a system call leading to a privileged instruction execution. In step 1308, process 1300 can insert validation code before a location of the set of privileged instructions and the API call. In step 1310, process 1300 can updating the application imace. In step 1312, process 1300 can resume the normal execution of the application.

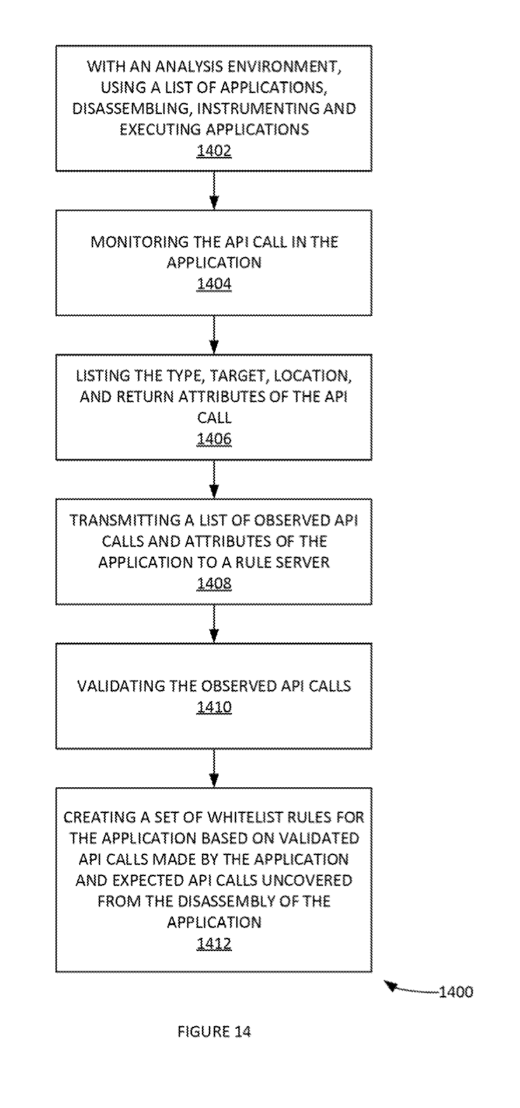

FIG. 14 illustrates an example process 1400 for creating and updating whitelist rules for use in validating API calls in applications, according to some embodiments. in step 1402, process 1400 can, with an analysis environment, use a list of applications, disassembling, instrumenting and executing applications. In step 1404, process 1400 can monitor the API call in the application. in step 1406, process 1400 can list the type, target, location, and return attributes of the API call. In step 1408, process 1400 can transmit a list of observed API calls and attributes of the application to a rule server;, In step 1410, process 1400 can validate the observed All calls. In step 1412, process 1400 can create a set of whitelist rules for the application based on validated API calls made by the application and expected API calls uncovered from the disassembly of the application. In step 1414, process 1400 can scan a computer system for an executing application. In step 1416, process 1400 can suspend an execution of the application for a duration of instrumentation of an image of the application. In step 1418, process 1400 can list an API and a system call leading to a privileged instruction execution. In step 1420, process 1400 can insert a validation code before a location of the set of privileged instructions and the API call. In step 1422, process 1400 can update the application image. In step 1424, process 1400 can resume the normal execution of the application.

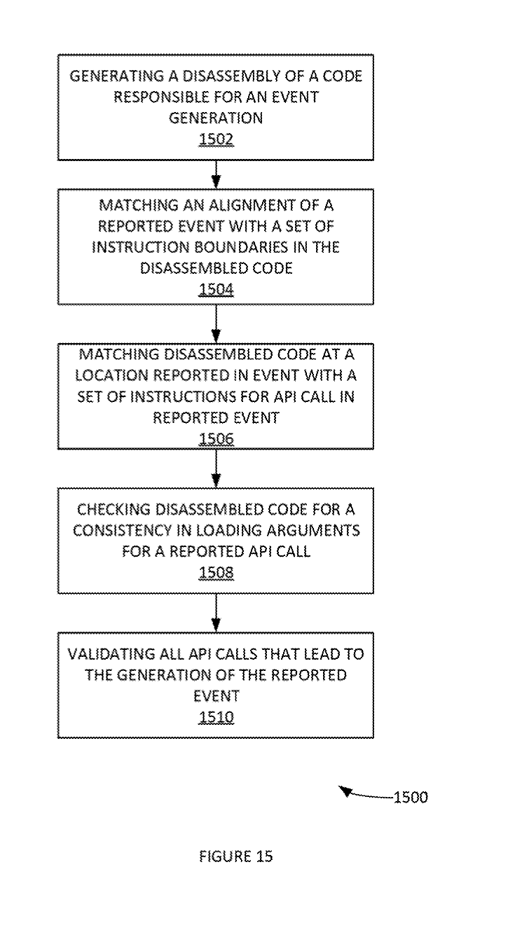

FIG. 15 illustrates an example process 1500 for applying additional validation to an event representing an API call execution, according to some embodiments. In step 1502, process 1500 can generate a disassembly of a code responsible for an event generation. In step 1504, process 1500 can match an alignment of a reported event with a set of instruction boundaries in the disassembled code. In step 1506, process 1500 can match the disassembled code at a location reported in the event with a set of instructions for the API call in the reported event. In step 1508, process 1500 can check the disassembled code for a consistency in loading arguments for a reported API call. In step 1510, process 1500 can validate all API calls that lead to the generation of the reported event.

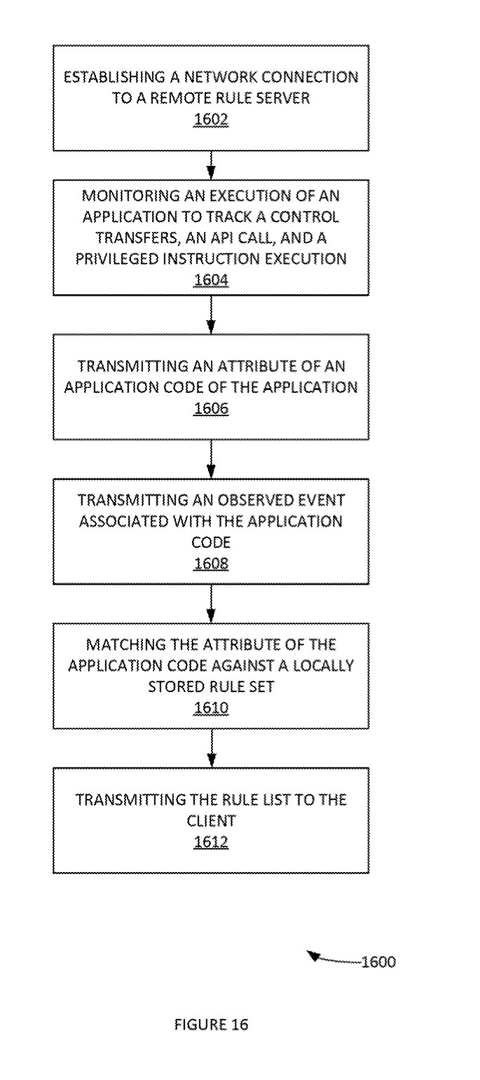

FIG. 16 illustrates an example process 1600 for reporting an observed API call and downloading a rule list for an execution of the API call, according to some embodiments. With a client computing device, in step 1602, process 1600 can establish a network connection to a remote rule server. In step 1604, process 1600 can monitor an execution of an application to track a control transfers, an API call, and a privileged instruction execution. In step 1606, process 1600 can transmit an attribute of an application code of the application. In step 1608, process 1600 can transmit an observed event associated with the application code. With the rule server, in step 1610, process 1600 can match the attribute of the application code against a locally stored rule set. In step 1612, process 1600 can transmit the rule list to the client.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firrnv are, software or any combinationhardware firmware, and software (e.g, embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense, in some embodiments, the machine-readable medium can be a non-transitory form of machine-readable medium.

What is claimed as new and desired to protected by Letters Patent of United States is:

1. A method for monitoring and validating execution of executable binary code, comprising the steps of:
disassembling an executable binary code application;
detecting and obtaining an application programming interface (API) call or a system call that is executed by the executable binary code;
listing a type of the API call;
listing a location of the API call,
listing a target of the APl call;
listing a location of return fro the API call;
detecting a privileged instruction that is executed by the executable binary code;
obtaining the privileged instruction that is executed by the executable binary code;
listing a type of the privileged instruction;
listing a location of the privileged instruction;
creating a rule set for validating the API call and the privileged instruction execution by the executable binary code;
transmitting the rule set to a validation code at an enforcerent point;
loading a rule set in the memory of the validation code, wherein the rule set pertains to an API call type, an API call target, an API call location, an API call return location, a privileged instruction type and a privileged instruction location;
during an execution of the application, monitoring the code to determine a conformity of the API call and the privileged instruction made by, the application with the rule set;
inserting a monitoring and validation code that, during execution of an application, generates an event based on the API call or the privileged instruction;
transmitting the event stating the type, location address, target address, and return address for the observed API call or the location of the privileged instruction;
transmitting the event based on the API call or the privileged instruction to a validator application, wherein the validator application validates the rule set;
with the validator application:
checking a conformity of the event based on the API cell or the privileged instruction with the rule set;
implementing a default action when a rule violation is detected for an event associated with an API call or a privileged instruction during the execution of the binary code; and
applying an additional validation for the API call and the privileged instruction in the executable binary code.

2. The method of claim 1, wherein the executable binary code comprises an application, a dynamic loaded library, a kernel module, a hypervisor, a set of firmware, or a memory page.

3. The method of claim 1, wherein the API call he privileged instruction is reported to a rule server and a corresponding rule is received.

4. The method of claim 1, wherein the API call location or the privileged instruction location validated with a specified disassembled structure of the binary executable code.

5. The method of claim 1, wherein the API call location is validated by verifying the argument used via analysis of the disassembled structure of the binary executable.

6. The method of claim 1, wherein the rule list is downloaded from the rule server and used to validate the API call and the privileged instruction executed by the application.

7. The method of claim 1, wherein a dynamic analysis is performed to determine the API call and the privileged instruction executed by the application and to create the rule set.

8. The method of claim 1, wherein the validation code at an enforcement point executes at a remote location.

9. The method of claim 1, wherein an additional information about a system state is reported to the rule server.

10. A method for validating execution of an application through a runtime validation process an observed application programming interface (API) call or a system call and a privileged instruction executed by the application, comprising the steps of:
scanning a computer system for an executing application; and
inserting a validator code into the computer system at a higher privileged level than the execution application, wherein the validator code monitors and validates the API call or the privileged instruction executed by the application.

11. The method of claim 10, wherein the validation of the API call and the privileged instruction executed by the pplication is implemented in the kernel of the computing system.

12. The ethod of claim 10, wherein the validation of the API call and the privileged instruction executed by the application is implemented in a hypervisor of the computing system.

13. The method of claim 10, wherein the validation of the API call and the privileged instruction executed by the application is implemented in a set of firmware of the computing system.

14. The method of claim 10, wherein the rule set uses the API call type and the API call location in a program memory for validation.

15. The method of claim 10, wherein an unknown API call or are ur unknown privileged instruction executed by the application is analyzed in a dynamic analysis environment and added to the rule list.

16. The method of claim 10, wherein the API call or the privileged instruction executed by the application is sociated with another API ca in the application code by analyzing a set stack frames.

17. A method for instrumentation of an application image useful validating an execution of an application comprising the steps of:
scanning a computer system for an executing application;
suspending an execution of the application for a duration of instrumentation of an image of the application;
listing an application programming interface API of a system call leading to a privileged instruction execution;
inserting a validation code before a location of the set of privileged instructions and the API call or the system call;
updating the application image; and
resuming execution of the application.

18. The method of claim 17, wherein an unknown API call in the application is analyzed in a virtual environment and added to a rule list.

19. The method of claim 17, wherein the validation code is inserted by the application.

20. The method of claim 17, wherein the validation code is inserted by an operating system of the computer system.

21. The method of claim 17, wherein the validation code is inserted by a virtual machine monitor.

22. The method of claim 17, wherein an attribute of the application and a corresponding memory page list is communicated to a hypervisor in the computer system.

23. The method of claim 17, wherein an application file handle is modified to point to an instrumented copy of an application executable.

24. The method of claim 17,
wherein the corresponding memory page is associated with the application, and
wherein the corresponding memory page is modified for inserting the validation code.

25. The method of claim 17, wherein the API call or the system call or the privileged instruction executed by the application is associated with another API call in the application code by analyzing a set of stack frames.

26. A method for creatingand updating vvhitelist rules use in validating app tion programming interface (API) calls in applications comprising steps of:
with an analysis environment, identifying a application i a list of applications:
disassembling an application in the list of applications,
instrumenting the application, and
executing the application;
monitoring an API call in the application;
listing a type of the API call, a target of the API call, a location of the API call, and a return attribute of the API call in a list of attributes of the application;
transmitting a list of observed API calls and the list of attributes of the application to a rule server;
validating the observed API calls; and
creating a set of whitelist rules for the application based on a set of validated API calls made by the application and expected API calls uncovered from a disassembly of the application.

27. The method of claim 26, wherein a static analysis is performed to list a set of attributes of the API call in the application.

28. The method of claim 26, wherein rule list adjusted to reflect a set of values in presence an instrumentation of the binary code for API call validation.

29. The method of claim 26, wherein a rule list for an application is obtained by the client from the rule server.

30. A method for applying an additional validation to an event representing an application programming interface (API) call execution comprising steps of:
generating a disassembled code, wherein the code is responsible for an event generation;
matching an alignment of a reported event with a set of instruction boundaries in the disassembled code;
matching the disassembled code at a location reported in an event with a set of instructions for the API call in the reported event;
checking the disassembled code for a consistencyin loading arguments fora reported API call; and
validating a set of API calls that ead t a generation of the reported event.

31. The method of claim 30, wherein a type for arguments supplied to the API call is validated by analyzing a disassembly of an application binary.

32. The method of claim 30, wherein a validity of an argument type is checked based on an argument loaded into a processor register.

33. The method of claim 30, wherein the validity of the argument type is supplied to the API call is validated by analyzing a pointer type associated with an address of the argument.

34. A method for reporting an observed application programming interface (API) call and downloading a rule list for an execution of the API call comprising steps of:
with a client computing device:
establishing a network connection to a remote rule server;
monitoring an execution of an application to track a control transfers, an API call, and a privileged instruction execution;
transmitting an attribute of an application code of the application; and
transmitting an observed event associated with the application code;
with the rule server:
matching the attribute of the application code against a locally stored rule; and
transmitting the rule list to the client.
